(19) United States
(12) Patent Application Publication
(10) Pub. No.: US 2024/0302076 A1
(43) Pub. Date: Sep. 12, 2024

(54) SOLAR APPLIANCE

(71) Applicant: William Rowling, Tacoma, WA (US)

(72) Inventor: William Rowling, Tacoma, WA (US)

(21) Appl. No.: 18/444,231

(22) Filed: Feb. 16, 2024

Related U.S. Application Data
(60) Provisional application No. 63/451,371, filed on Mar. 10, 2023.

(51) Int. Cl. F24S 20/30; F16L 59/065; F24S 70/16; F24S 80/60

(52) U.S. Cl. CPC F24S 20/30; F16L 59/065; F24S 70/16; F24S 80/60

(57) ABSTRACT

A solar appliance includes first and second double-wall bowls, each having an outer wall and inner wall spaced inwardly of the outer wall with at least partial vacuum therebetween. The first and the second double-wall bowls each having an opening that provides passage between an interior and an exterior thereof. The outer walls are at least translucent and the inner walls have an opaque solar radiation absorbing material. A gasket detachably mates the first double-wall bowl with the second double-wall bowl at least proximate respective rims thereof in inverted relationship. A vessel with a rim is positionable in the interior of the first double-wall bowl, with the rim of the vessel extending beyond the rim of the first double-wall bowl to help secure the second double-wall bowl to the first double-wall bowl. A vent, for example in the gasket, can vent the interior to the exterior.

### TECHNICAL FIELD

The present disclosure generally relates to solar appliances, for example solar ovens, that can be used to heat food, liquids or other materials using solar insolation.

### BACKGROUND

### Description of the Related Art

Solar appliances can be employed to heat food, liquids or other materials using solar insolation, typically without any active or powered (e.g., resistive) source of heat.

Various attempts have been made to design a solar appliance that is efficient, robust, readily manufactured and affordable.

### BRIEF SUMMARY

Described herein are various implementations of solar appliances that are efficient, robust, readily manufactured and affordable.

In at least some aspects, a solar appliance may be summarized as including: a first double-wall bowl, the first double-wall bowl having an outer wall and inner wall, the inner wall spaced inwardly of the outer wall with an at least partially evacuated volume between the inner wall and the outer wall of the first double-wall bowl, the inner wall having an interior surface that at least partially delimits an interior of the first double-wall bowl, the first double-wall bowl having an opening that provides passage between the interior of the first double-wall bowl and an exterior thereof, the opening delimited by a rim of the first double-wall bowl, the outer wall of the first double-wall bowl being at least translucent to solar insolation and the inner wall of the first double-wall bowl at least one of: comprising or carrying an opaque solar radiation absorbing material; a second double-wall bowl, the second double-wall bowl having an outer wall and inner wall, the inner wall spaced inwardly of the outer wall with an at least partially evacuated volume between the inner wall and the outer wall of the second double-wall bowl, the inner wall having an interior surface that at least partially delimits an interior of the second double-wall bowl, the second double-wall bowl having an opening that provides passage between the interior of the second double-wall bowl and an exterior thereof, the opening delimited by a rim of the second double-wall bowl, the outer wall of the second double-wall bowl being at least translucent to solar insolation and the inner wall of the second double-wall bowl at least one of comprising or carrying an opaque solar radiation absorbing material; a gasket dimensioned to detachably mate the first double-wall bowl with the second double-wall bowl at least proximate the respective rims of the first and the second double-wall bowls; and a vessel having an opening with a rim and which, when positioned in the interior of the first double-wall bowl, the rim of the vessel extends beyond the rim of the first double-wall bowl.

The solar appliance can include a vent that vents a volume delimited by the interiors of the first and the second double-wall bowls to an external environment. In some implementations, the vent passes through the gasket.

In some implementations, the outer walls of the first and the second double-wall bowls are transparent to solar insolation.

In some implementations, the opaque solar radiation absorbing material of the inner walls of the first and the second double-wall bowls are black or are arrays of carbon fiber nano tubes.

In some implementations, the opaque solar radiation absorbing material coats at least one of an outer surface or the inner surface of the inner walls of the first and the second double-wall bowls. In some implementations, the opaque solar radiation absorbing material is encompassed in the inner walls of the first and the second double-wall bowls.

In some implementations, the vessel is a bowl, the vessel having an outer surface and an inner surface, the inner surface delimiting a cooking volume of the vessel, the outer surface of the vessel comprising or carrying an opaque solar radiation absorbing material.

In some implementations, the inner wall of the first double-wall bowl is a monocoque structure and the inner wall of the second double-wall bowl is a monocoque structure.

In some implementations, the inner wall of the first double-wall bowl is a truncated sphere and the inner wall of the second double-wall bowl is a truncated sphere.

In some implementations, a portion of the inner wall of the first double-wall bowl forms a bottom and the rim of the vessel extends beyond the rim of the first double-wall bowl when the vessel is supported by the bottom.

In some implementations, at least the outer walls of the first and the second double-wall bowls are comprised of a borosilicate glass. In some implementations, the inner walls of the first and the second double-wall bowls are comprised of a borosilicate glass.

In some implementations, the inner walls of the first and the second double-wall bowls are comprised of a metal.

In some implementations, the inner wall of the first double-wall bowl is one of fused or welded to the outer wall of the first double-wall bowl.

In some implementations, the gasket takes the form of an annular member secured about the rim of one of the first or the second double-wall bowls and having a groove to removably accommodate the rim of the other one of the first or the second double-wall bowls to provide a sealing engage therebetween.

In some implementations, the gasket includes a room temperature vulcanizing (RTV) silicone.

In some implementations, the solar appliance includes at least one handle that extends from at least one of the first double-wall bowl or the second double-wall bowl.

In some implementations, the solar appliance includes a stand, the stand having an annular support ring dimensioned to support the first double-wall bowl for rotation about at least two orthogonal axes.

In some implementations, the solar appliance includes a reflector positionable with respect to the first and the second double-wall bowls to reflect solar insolation thereto.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is an isometric view of a solar appliance that includes first and second double-wall bowls, detachably mated in inverted relationship with one another via a gasket, with a vessel positionable in an interior with a rim that extends beyond a rim of the first double-wall bowl to help secure the second double-wall bowl to the first double-wall bowl, according to one illustrated implementation.

FIG. 2 is an isometric view of the solar appliance of FIG. 1 with the first and second double-wall bowls detached from one another and better illustrating the gasket, according to one illustrated implementation.

FIG. 3 is an exploded view of the solar appliance of FIGS. 1 and 2 with the inner and the outer walls or shells of the first and second double-wall bowls shown spaced from one another to better illustrate the structure and manufacture of the first and second double-walled bowls, according to one illustrated implementation.

FIG. 4A is a detailed view of a portion of one of the double-walled bowls illustrating an opaque solar radiation absorbing material on an outer surface of the inner wall or shell thereof, according to one illustrated implementation.

FIG. 4B is a detailed view of a portion of one of the double-walled bowls illustrating an opaque solar radiation absorbing material on an inner surface of the inner wall or shell thereof, according to one illustrated implementation.

FIG. 4C is a detailed view of a portion of one of the double-walled bowls illustrating an opaque solar radiation absorbing material in the inner wall or shell thereof, according to one illustrated implementation.

FIG. 5 is an isometric view of the solar appliance of FIGS. 1 and 2 along with a stand and a reflector, according to one illustrated implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other components, materials, methods, etc. In other instances, well-known structures associated solar appliances have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in on implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

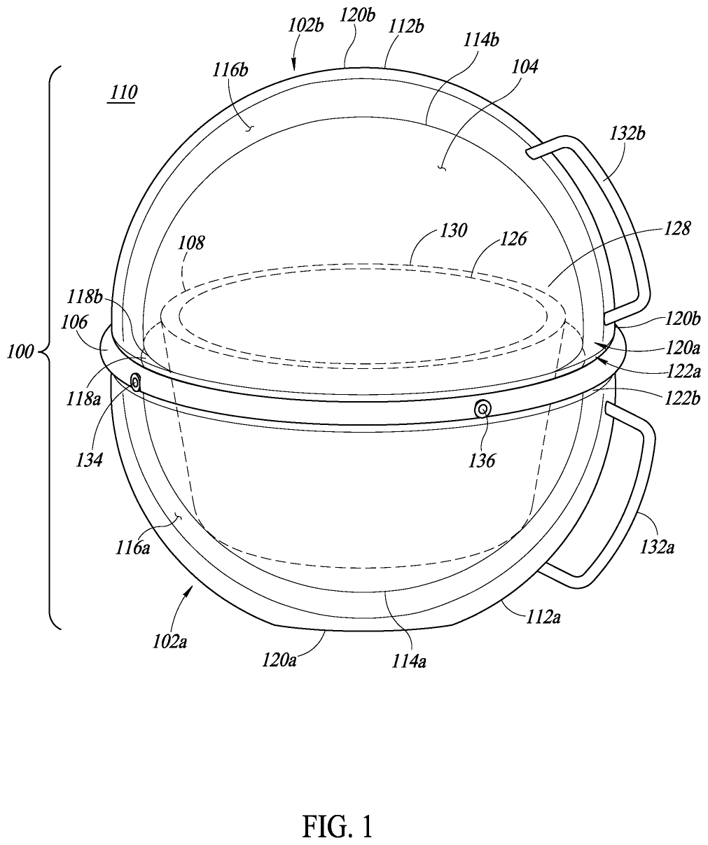

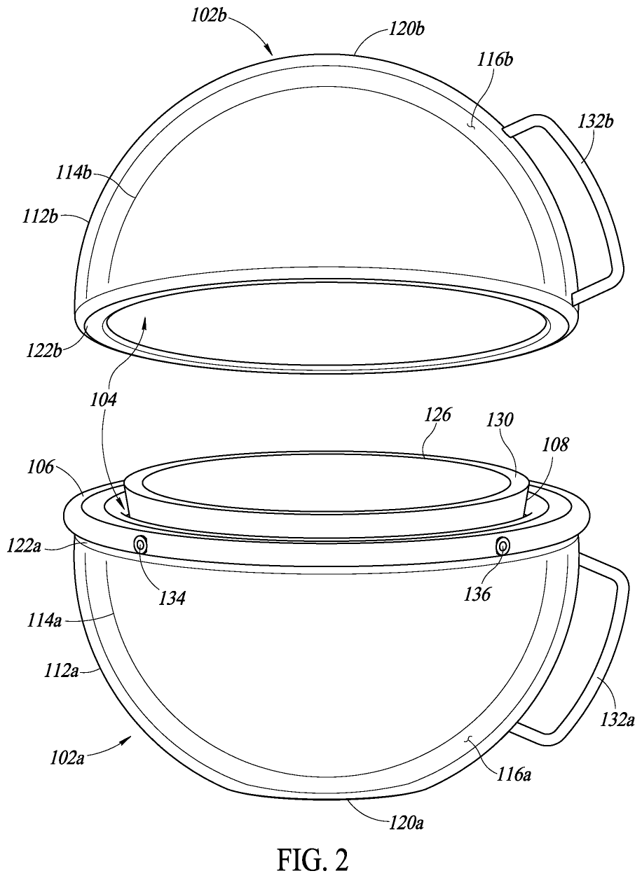

FIGS. 1, 2 and 3 show a solar appliance 100, according to one illustrated implementation.

The solar appliance 100 includes a first double-wall bowl 102a and a second double-wall bowl 102b. The second double-wall bowl 102b in use is detachably mated in inverted relationship with the first double-wall bowl 102a. The mated first and second double-wall bowls 102a, 102b have an interior 104 in which materials to be heated are placed.

The solar appliance 100 can includes a gasket 106 that detachably mates the second double-wall bowl 102b in inverted relationship with the first double-wall bowl 102a. The solar appliance 100 can also include a vessel 108 (e.g., cooking vessel, pot, kettle, bowl, cup, mug, plate) that, at least during use, is positioned or positionable in the interior 104 of the mated first and second double-wall bowls 102a, 102b of the solar appliance 100.

The detachable mating of the first and second double-wall bowls 102a, 102b selectively provides access to the interior 104 from an exterior 110 thereof, for instance to insert material to be heated (e.g., food, liquids) and/or to retrieve heated materials from the interior 104. Such can also selectively provide access to the interior 104 from the exterior 110 thereof, for instance to insert the vessel 108 into the interior 104 and/or retrieve the vessel 108 from the interior 104, for example to retrieve heated materials, or for cleaning the vessel 108.

The first double-wall bowl 102a has an outer wall 112a and an inner wall 114a, the inner wall 112a spaced inwardly (e.g., radially inwardly) of the outer wall 114a, or in other words the outer wall 114a is spaced outwardly of the inner wall 112a, with a space 116a defined between the inner and the outer walls 112a, 114a. The space 116a between the inner and the outer walls 112a, 114a is an at least partially evacuated volume (e.g., an at least partial vacuum, for instance approaching 30 inches of mercury).

The first double-wall bowl 102a has an opening 118a at one end 120a (e.g., top end) that provides access into the interior 104 of the first double-wall bowl 102a. The firs double-wall bowl 102a has a rim 122a that extends about a periphery of the opening 118a. The rim 122a can include one or more securement features or attachment points to, for example, secure the gasket 106 thereto.

In some implementations, the inner wall 114a of the first double-wall bowl 102a is a monocoque structure. In some implementations, the inner wall 114a of the first double-wall bowl 102a can take the form of a truncated sphere, the sphere truncated at the opening 118a. A spherical or truncated spherical shape can uniformly spread stress in the inner wall 114a resulting from repeated temperature cycling, thereby reducing fatigue cracking and improving the expected life of the solar appliance 100 (e.g., solar oven).

In some implementations, the outer wall 112a of the first double-wall bowl 102a is a monocoque structure. In some implementations, the outer wall 112a of the first double-wall bowl 102a can take the form of a truncated sphere, the sphere truncated at the opening 118a. Alternatively, the outer wall 112a of the first double-wall bowl 102a can, for example, take the form of a non-spherical body of revolution.

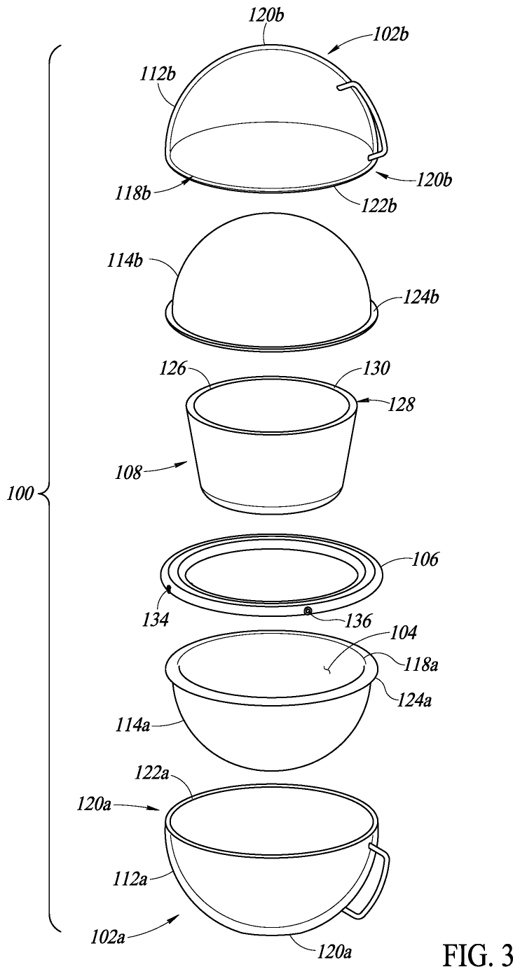

As best illustrated in FIG. 3, the first double-wall bowl 102a can be constructed from an outer shell that forms the outer wall 112a and an inner shell that forms the inner wall 114a. The inner wall 114a or inner shell has an interior surface that at least partially delimits an interior of the first double-wall bowl 102a.

The outer wall 112a or outer shell of the first double-wall bowl 102a is at least translucent to solar insolation, and preferably transparent to the various wavelengths of solar radiation. The inner wall 114a or inner shell of the first double-wall bowl 102a at least one of: comprises or carries an opaque solar radiation absorbing material. In some implementations, the opaque solar radiation absorbing material of the inner walls of the first and the second double-wall bowls 102a, 102b are black or are arrays of carbon fiber nano tubes. In some implementations, the opaque solar radiation absorbing material may be omitted from a portion of the inner walls of one or both of the first and the second double-wall bowls 102a, 102b to form a window which allows the contents in the interior 104 to be viewed from the exterior 110, for example while cooking.

In some implementations, at least the outer wall 112a of the first double-wall bowl 102a is comprised of a borosilicate glass. In some implementations, the inner wall 114a of the first double-wall bowl 102a are comprised of a borosilicate glass. In some implementations, the inner wall 114a of the first double-wall bowls 102a is comprised of a metal (e.g., copper, aluminum).

One or both of the outer wall 112a and inner wall 112b, or the outer shell and inner shell, can include a peripheral flange 124a that can used to attach the inner wall 112a or inner shell to the outer wall 114a or outer shell, and which closes the space 116a between the outer and the inner walls 112a, 114a. The inner wall 114a or inner shell can be attached to the outer wall 112a or outer shell via a variety of techniques, for example via fusing, welding, heat sealing and/or adhesives. In some implementations the peripheral flange 124a can encompass or form the rim 122a of the first double-wall bowl 102a. In some implementations the peripheral flange 124a can include one or more securement features or attachment points to secure the gasket 106 thereto.

The second double-wall bowl 102b has an outer wall 112b and an inner wall 114b, the inner wall 112b spaced inwardly (e.g., radially inwardly) of the outer wall 114b, or in other words the outer wall 114b is spaced outwardly of the inner wall 112b, with a space 116b defined between the inner and the outer walls 112b, 114b. The space 116b between the inner and the outer walls 112b, 114b is an at least partially evacuated volume (e.g., an at least partial vacuum).

The second double-wall bowl 102b has an opening 118b at one end 120b (e.g., bottom end) that provides access into the interior 104 of the second double-wall bowl 102b. The second double-wall bowl 102b has a rim 122b that extends about a periphery of the opening 118b. The rim 122b can optionally include one or more securement features or attachment points to, for example, secure the gasket 106 thereto, although typically one a single gasket 106 will be employed. The rim 122b and/or the opening 118b of the second double-wall bowl 102b can match the rim 122a and/or the opening 118a of the first double-wall bowl 102b in shape and/or dimensions.

In some implementations, the inner wall 114b of the second double-wall bowl 102b is a monocoque structure. In some implementations, the inner wall 114b of the second double-wall bowl 102b can take the form of a truncated sphere, the sphere truncated at the opening 118b. A spherical or truncated spherical shape can uniformly spread stress in the inner wall 114b resulting from repeated temperature cycling, thereby reducing fatigue cracking and improving the expected life of the solar appliance 100 (e.g., solar oven).

In some implementations, the outer wall 112b of the second double-wall bowl 102b is a monocoque structure. In some implementations, the outer wall 112b of the second double-wall bowl 102b can take the form of a truncated sphere, the sphere truncated at the opening 118b and at a bottom end 120b to allow the second double-wall bowl 102b to be supported on a flat surface (e.g., table). Alternatively, the outer wall 112b of the second double-wall bowl 102b can, for example, take the form of a non-spherical body of revolution.

As best illustrated in FIG. 3, the second double-wall bowl 102b can be constructed from an outer shell that forms the outer wall 112b and an inner shell that forms the inner wall 114b. The inner wall 114b or inner shell has an interior surface that at least partially delimits an interior of the second double-wall bowl 102b.

The outer wall 112b or outer shell of the second double-wall bowl 102b is at least translucent to solar insolation, and preferably transparent to the various wavelengths of solar radiation. The inner wall 114b or inner shell of the second double-wall bowl 102b at least one of: comprises or carries an opaque solar radiation absorbing material. In some implementations, the opaque solar radiation absorbing material of the inner walls of the first and the second double-wall bowls 102a, 102b are black or are arrays of carbon fiber nano tubes.

In some implementations, at least the outer wall 112b of the first double-wall bowl 102b is comprised of a borosilicate glass. In some implementations, the inner wall 114b of the second double-wall bowl 102b are comprised of a borosilicate glass. In some implementations, the inner wall 114b of the first double-wall bowls 102a is comprised of a metal (e.g., copper, aluminum).

One or both of the outer wall 112b and inner wall 112b, or the outer shell and inner shell, can include a peripheral flange 124b that can used to attach the inner wall 112b or inner shell to the outer wall 114b or outer shell, and which closes the space 116b between the outer and the inner walls 112b, 114b. The inner wall 114b or inner shell can be attached to the outer wall 112b or outer shell via a variety of techniques, for example via fusing, melting, welding, heat sealing and/or adhesives. In some implementations the peripheral flange 124b can encompass or form the rim 122b of the second double-wall bowl 102b. In some implementations the peripheral flange 124b can include one or more securement features or attachment points to secure the gasket 106 thereto.

The vessel 108 has an opening 126 at one end 128 thereof, with a rim 130 that extends about a periphery of the vessel 108. The rim 130 of the vessel 108 extends beyond (e.g., vertically above) a rim 122a of the first double-wall bowl 102a when the vessel 108 is positioned in the interior 104 to help secure the second double-wall bowl 102b to the first double-wall bowl 102a. For example, in some implementations a portion of the inner wall 114a of the first double-wall bowl 102a forms a bottom and the rim 130 of the vessel 108 extends beyond the rim 122a of the first double-wall bowl 102a when the vessel 108 is supported by the bottom of the inner wall 114a of the first double-wall bowl 102a. Alternatively, the vessel 108 and/or the inner wall 114a of the first double-wall bowl 102a can include one or more other retainment or support features (e.g., pins, pegs, lips, feet, fingers, hangers, ears) to support the vessel 108 such that the rim 130 of vessel 108 extends beyond (e.g., vertically above) the rim 122a of first double-wall bowl 102a. The approaches can advantageously, for instance, restrain the second double-wall bowl 102b from shifting laterally with respect to first double-wall bowl 102a, for example when a knocked and/or when pressure builds up in the interior 104.

In some implementations, the vessel 108 is, for example, a cooking vessel, pot, kettle, bowl, cup, mug, or plate. The vessel 108 can have an outer surface and an inner surface, the inner surface delimiting a cooking volume of the vessel 108. The outer surface of the vessel 108 optionally comprising or carrying an opaque solar radiation absorbing material.

The gasket 106 can, for example, comprise or consist of a room temperature vulcanizing (RTV) silicone. In some implementations, the gasket 106 takes the form of an annular member secured about the rim of one of the first or the second double-wall bowls 102a, 102b and having a groove to removably accommodate the rim of the other one of the first or the second double-wall bowls 102a, 102b to provide a sealing engage therebetween.

In some implementations, the solar appliance optionally includes at least one handle 132a, 132b (two shown) that extends from at least one of the first double-wall bowl 102a or the second double-wall bowl 102b. In some implementations, the handle(s) 132a, 132b can be formed by tubes or conduits used to evacuate the space 116a, 116b.

The solar appliance 100 can optionally include one or more vents 134 that vent the interior 104 (volume delimited by the inner walls 114a, 114b of the first and the second double-wall bowls 102a, 102b) to an external environment. In some implementations, the vent passes through the gasket. The vent 134 can, for example provide a passage, and the passage can optionally be a one-way passage (e.g., check valve) that allow passage of fluids (e.g., heated air) outward toward the exterior 110.

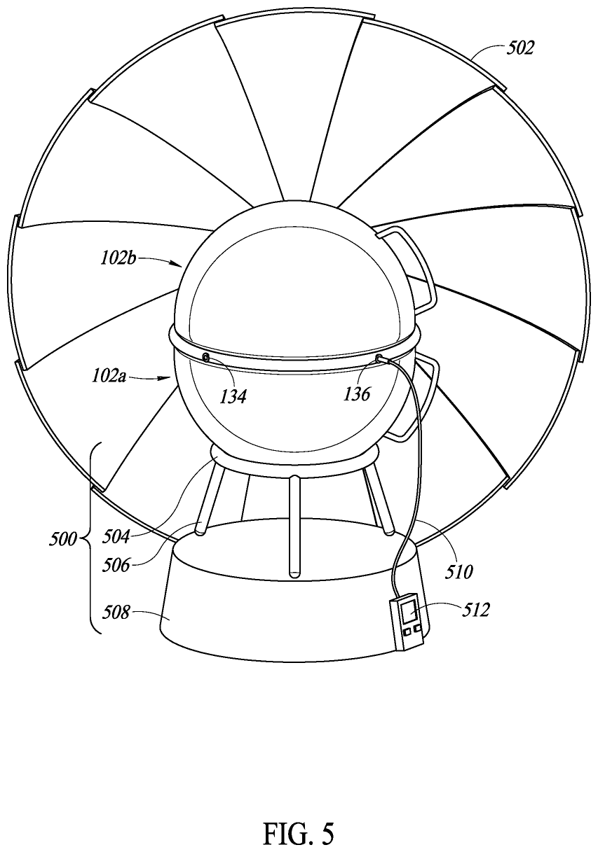

The solar appliance 100 can optionally include one or more access ports 136 that provide access (e.g., for wires or cables 510, FIG. 5) to the interior 104 (volume delimited by the inner walls 114a, 114b of the first and the second double-wall bowls 102a, 102b) from the external environment. In some implementations, the access port(s) passes through the gasket 106. Such can, for example, facilitate the use of external thermometers 512 (FIG. 5) with an internal thermocouple(s) to monitor a temperature in the interior 104.

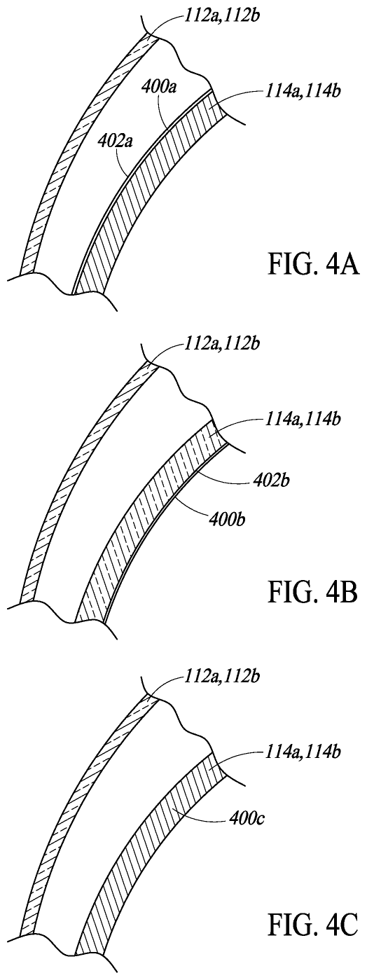

As illustrated in FIG. 4A, in some implementations the opaque solar radiation absorbing material 400a coats an outer surface 402a of the inner walls 114a, 114b of the first and the second double-wall bowls 102a, 102b. The opaque solar radiation absorbing material 400a can be a black color, paint, powder (e.g., powder coated), enamel, or deposition. The opaque solar radiation absorbing material 400a can be an array of carbon fiber nano tubes.

As illustrated in FIG. 4B, in some implementations the opaque solar radiation absorbing material coats the inner surface of the inner walls 114a, 114b of the first and the second double-wall bowls 102a, 102b. The opaque solar radiation absorbing material 400b can be a black color, paint, powder (e.g., powder coated), enamel, or deposition. The opaque solar radiation absorbing material 400b can be an array of carbon fiber nano tubes.

As illustrated in FIG. 4C, in some implementations, in some implementations the opaque solar radiation absorbing material is encompassed in the inner walls 114a, 114b of the first and the second double-wall bowls 102a, 102b. The opaque solar radiation absorbing material 400c can be a black color, paint, powder (e.g., powder coated), enamel, or deposition. The opaque solar radiation absorbing material 400c can be an array of carbon fiber nano tubes.

FIG. 5 shows the solar appliance 100 of FIGS. 1-3 that include a stand 500 and a reflector 502, according to at least one illustrated implementation.

The stand 500 has an annular support ring 504, dimensioned to support the first double-wall bowl 102a, preferably for rotation about at least two orthogonal axes. The stand 500 can optionally one or more legs 506 (only one called out), for instance extending from the annular support ring 504. The stand 500 can optionally include a base 508. The base 508 can, for example, provide a platform for the annular support ring 504 and legs 506. The base 508 can optionally support the external thermometer 512.

The reflector 502 is positionable with respect to the first and the second double-wall bowls 102a, 102b to reflect solar insolation thereto. While illustrated as parabolic, the reflector 502 can have any of a wide variety of shapes (e.g., conical).

The various implementations described above can be combined to provide further implementations. Aspects of the implementations can be modified, if necessary, to employ systems, circuits and concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A solar appliance, comprising:
a first double-wall bowl, the first double-wall bowl having an outer wall and inner wall, the inner wall spaced inwardly of the outer wall with an at least partially evacuated volume between the inner wall and the outer wall of the first double-wall bowl, the inner wall having an interior surface that at least partially delimits an interior of the first double-wall bowl, the first double-wall bowl having an opening that provides passage between the interior of the first double-wall bowl and an exterior thereof, the opening delimited by a rim of the first double-wall bowl, the outer wall of the first double-wall bowl being at least translucent to solar insolation and the inner wall of the first double-wall bowl at least one of: comprising or carrying an opaque solar radiation absorbing material;
a second double-wall bowl, the second double-wall bowl having an outer wall and inner wall, the inner wall spaced inwardly of the outer wall with an at least partially evacuated volume between the inner wall and the outer wall of the second double-wall bowl, the inner wall having an interior surface that at least partially delimits an interior of the second double-wall bowl, the second double-wall bowl having an opening that provides passage between the interior of the second double-wall bowl and an exterior thereof, the opening delimited by a rim of the second double-wall bowl, the outer wall of the second double-wall bowl being at least translucent to solar insolation and the inner wall of the second double-wall bowl at least one of comprising or carrying an opaque solar radiation absorbing material;
a gasket dimensioned to detachably mate the first double-wall bowl with the second double-wall bowl at least proximate the respective rims of the first and the second double-wall bowls; and
a vessel having an opening with a rim and which, when positioned in the interior of the first double-wall bowl, the rim of the vessel extends beyond the rim of the first double-wall bowl.

2. The solar appliance of claim 1, further comprising:
a vent that vents a volume delimited by the interiors of the first and the second double-wall bowls to an external environment.

3. The solar appliance of claim 2 wherein the vent passes through the gasket.

4. The solar appliance of claim 1 wherein the outer walls of the first and the second double-wall bowls are transparent to solar insolation.

5. The solar appliance of claim 1 wherein the opaque solar radiation absorbing material of the inner walls of the first and the second double-wall bowls are black.

6. The solar appliance of claim 1 wherein the opaque solar radiation absorbing material of the inner walls of the first and the second double-wall bowls are arrays of carbon fiber nano tubes.

7. The solar appliance of claim 1 wherein the opaque solar radiation absorbing material coats at least one of an outer surface or the inner surface of the inner walls of the first and the second double-wall bowls.

8. The solar appliance of claim 1 wherein the opaque solar radiation absorbing material is encompassed in the inner walls of the first and the second double-wall bowls.

9. The solar appliance of claim 1 wherein the vessel is a bowl, the vessel having an outer surface and an inner surface, the inner surface delimiting a cooking volume of the vessel, the outer surface of the vessel comprising or carrying an opaque solar radiation absorbing material.

10. The solar appliance of claim 1 wherein the inner wall of the first double-wall bowl is a monocoque structure and the inner wall of the second double-wall bowl is a monocoque structure.

11. The solar appliance of claim 1 wherein the inner wall of the first double-wall bowl is a truncated sphere and the inner wall of the second double-wall bowl is a truncated sphere.

12. The solar appliance of claim 1 wherein a portion of the inner wall of the first double-wall bowl forms a bottom and the rim of the vessel extends beyond the rim of the first double-wall bowl when the vessel is supported by the bottom.

13. The solar appliance of claim 1 wherein at least the outer walls of the first and the second double-wall bowls are comprised of a borosilicate glass.

14. The solar appliance of claim 1 wherein the inner walls of the first and the second double-wall bowls are comprised of a borosilicate glass.

15. The solar appliance of claim 1 wherein the inner walls of the first and the second double-wall bowls are comprised of a metal.

16. The solar appliance of claim 1 wherein the inner wall of the first double-wall bowl is one of fused or welded to the outer wall of the first double-wall bowl.

17. The solar appliance of claim 1 wherein the gasket comprises an annular member secured about the rim of one of the first or the second double-wall bowls and having a groove to removably accommodate the rim of the other one of the first or the second double-wall bowls to provide a sealing engage therebetween.

18. The solar appliance of claim 1 wherein the gasket comprises a room temperature vulcanizing (RTV) silicone.

19. The solar appliance of claim 1, further comprising:
at least one handle that extends from at least one of the first double-wall bowl or the second double-wall bowl.

20. The solar appliance of claim 1, further comprising:
a stand, the stand having an annular support ring dimensioned to support the first double-wall bowl for rotation about at least two orthogonal axes; and
a reflector positionable with respect to the first and the second double-wall bowls to reflect solar insolation thereto.
